(19) United States
(12) Patent Application Publication
(10) Pub. No.: US 2017/0078573 A1
(43) Pub. Date: Mar. 16, 2017

(54) Adaptive Power Saving For Multi-Frame Processing

(71) Applicant: MediaTek Inc., Hsinchu City (TW)

(72) Inventors: Ding-Yun Chen, Taipei City (TW); Cheng-Tsai Ho, Taichung City (TW)

(21) Appl. No.: 15/361,067

(22) Filed: Nov. 24, 2016

Related U.S. Application Data
(60) Provisional application No. 62/260,352, filed on Nov. 27, 2015.

(51) Int. Cl. H04N 5/232

(52) U.S. Cl. CPC H04N 5/23241; H04N 5/23229

(57) ABSTRACT

Methods and apparatuses pertaining to adaptive power saving for multi-frame processing may involve monitoring for at least one condition associated with an apparatus. In response to a result of the monitoring, image processing performed on a plurality of input image frames may be dynamically adjusted to provide one or more output image frames.

### CROSS REFERENCE TO RELATED PATENT APPLICATION(S)

The present disclosure is part of a non-provisional application claiming the priority benefit of U.S. Patent Application No. 62/260,352, filed on 27 Nov. 2015, which is incorporated by reference in its entirety.

### TECHNICAL FIELD

The present disclosure is generally related to image processing and, more particularly, to adaptive power saving for multi-frame processing.

### BACKGROUND

Unless otherwise indicated herein, approaches described in this section are not prior art to the claims listed below and are not admitted to be prior art by inclusion in this section.

Multiple-frame (herein interchangeably referred as “multi-frame”) applications are generally applications that use image processing technology/technologies to generate one or more output image frames from multiple captured image frames. The multiple captured image frames can be captured by a single camera at different times, by multiple cameras at a same time, or by multiple cameras at different times. The multiple captured image frames can go through multi-frame processing (MFP), which generates at least one video frame from the multiple captured image frames for quality improvement. The quality improvement may be with respect to brightness, color, contrast, noise, sharpness, texture, frame rate, temporal smoothness, and so forth. MFP can be applied to still images, video recording files, as well as a video preview shown on a display.

With respect to MFP, existing approaches typically use the same image capture condition and video frame processing algorithm for each video frame. As a result, power consumption tends to be similar in the generation of each video frame with MFP. However, for portable applications that operate on a limited amount of power supply such as battery (e.g., smartphones, tablets, laptop computers and any battery-powered portable apparatus), the power consumption related to MFP can be excessive and is thus undesirable. Moreover, under high power consumption, high thermal condition (e.g., high temperature in one or more components) due to the high power consumption can result and, undesirably, lead to shutdown of the portable apparatus.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose a novel scheme for adaptive power saving for MFP. In one aspect, a method in accordance with the present disclosure may involve monitoring for at least one condition associated with an apparatus. The method may also involve dynamically adjusting image processing performed on a plurality of input image frames to provide one or more output image frames in response to a result of the monitoring.

In another aspect, an apparatus in accordance with the present disclosure may include a processor configured to monitor for at least one condition associated with an apparatus and, in response to a result of the monitoring, dynamically adjust image processing performed on a plurality of input image frames to provide one or more output image frames.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario depicting the basic concept of the proposed scheme of the present disclosure.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in accordance with an implementation of the present disclosure.

FIG. 5 is a diagram of an example scenario in accordance with an implementation of the present disclosure.

FIG. 6 is a diagram of an example scenario in accordance with an implementation of the present disclosure.

FIG. 7 is a diagram of an example scenario in accordance with an implementation of the present disclosure.

FIG. 8 is a block diagram of an example apparatus in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Under the proposed scheme of the present disclosure, power consumption in connect with image frame processing may be reduced adaptively, or dynamically, based on one or more real-time conditions being monitored at the time of image frame processing. In particular, under the proposed scheme, utilization of MFP may be dynamically enabled/disabled, adjusted, throttled or otherwise controlled to result in power saving by adapting to the one or more real-time conditions of the apparatus. MFP may be utilized to improve quality in output image frames that are generated by processing input images, at least in terms of one or more of the following non-exhaustive list of aspects: denoising, deblurring, super-resolution, better high dynamic range, better sharpness, better texture, better brightness, better color and better contrast.

The condition being monitored may be any condition in concern with respect to the apparatus associated with the camera. It is noteworthy that, although in examples described herein the condition being monitored may be the thermal condition of one or more components of the apparatus, in various implementations in accordance with the present disclosure the condition being monitored may be one or more non-thermal conditions with respect to the apparatus. It is noteworthy that more than one condition with respect to the apparatus may be monitored for dynamically controlling MFP in accordance with the present disclosure. For example and without limitation, one or more conditions being monitored may include at least one of the following: one or more temperatures associated with the apparatus reaching or exceeding one or more respective thermal thresholds, one or more temperatures associated with a camera of the apparatus reaching or exceeding one or more respective thermal thresholds, an amount of time that the apparatus has been in use reaching or exceeding a respective temporal threshold, an amount of time that the camera has been in use reaching or exceeding a respective temporal threshold, and an amount of time that an application has been in execution on the apparatus reaching or exceeding a respective temporal threshold. It is further noteworthy that, in addition to or in lieu of controlling MFP, one or more other actions may be taken to achieve power saving in accordance with the present disclosure. For example and without limitation, power saving may be achieved by lowering camera input frame rate, disabling MFP, lowering computation precision in hardware and/or in software (e.g., from 32 bits to 16 bits), and/or turning off one or more parallel hardware tasks and/or one or more parallel software tasks.

The term “thermal condition” herein may refer to the temperature(s) of one or more components of the apparatus such as, for example and without limitation, one or more processors, one or more electronic components and/or a casing of the apparatus. For example, when the temperature of a given component being monitored is below a first threshold, thermal condition with respect to that component (and/or the apparatus) may be deemed as being low; and when the temperature of that component is above a second threshold, thermal condition with respect to that component (and/or the apparatus) may be deemed as being high. In some implementations, the first threshold and the second threshold may be the same threshold. Alternatively, the first threshold may be different and lower than the second threshold. In such cases, the thermal condition may be deemed as being medium when the temperature of that component is between the first threshold and the second threshold.

The terms “input frame” and “input image frame” are used interchangeably herein. The terms “output frame” and “output image frame” are used interchangeably herein.

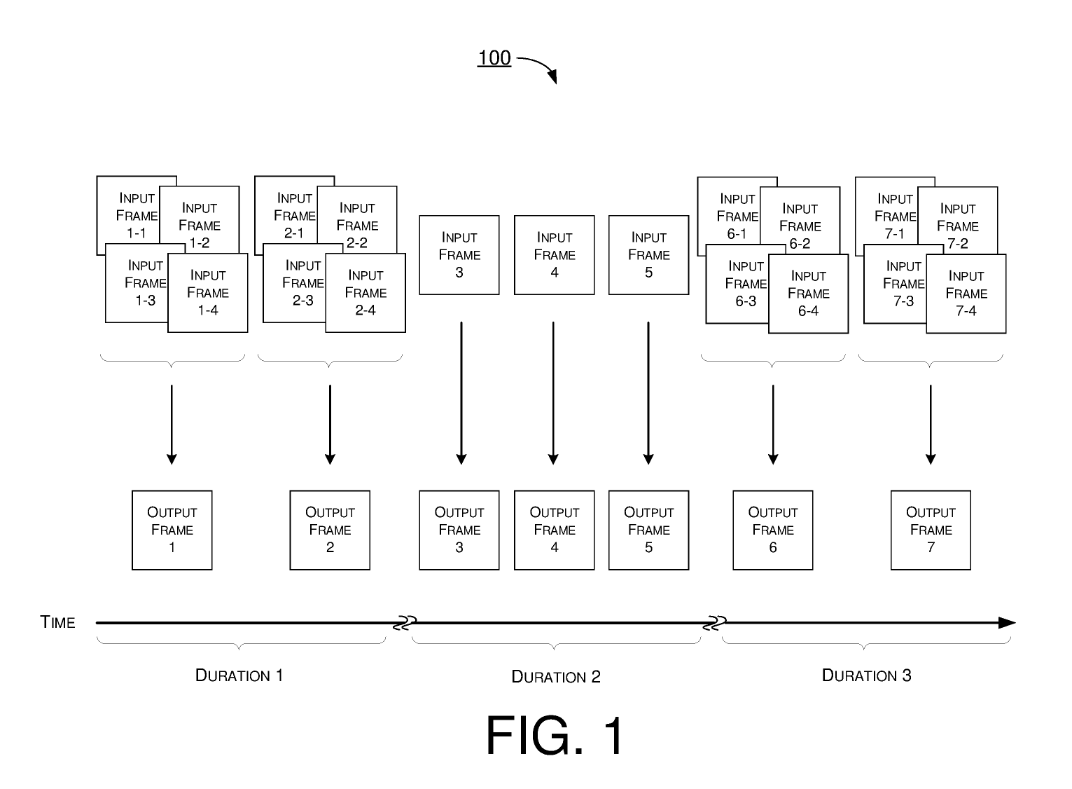

FIG. 1 illustrates an example scenario 100 depicting the basic concept of the proposed scheme of the present disclosure. In scenario 100, when image capture condition is suitable for MFP (e.g., during the time period of “duration 1” shown in FIG. 1), the proposed scheme may perform MFP by processing multiple captured images for each output image frame to achieve improved quality. As shown in FIG. 1, during duration 1, multiple input images 1-1, 1-2, 1-3 and 1-4 are used for MFP to generate a corresponding output frame 1. Similarly, multiple input images 2-1, 2-2, 2-3 and 2-4 are used for MFP to generate a corresponding output frame 2. In scenario 100, when image capture condition is not suitable for MFP (e.g., during the time period of “duration 2” shown in FIG. 1), the proposed scheme may switch from MFP to another by of processing in lieu of MFP to reduce power consumption. As shown in FIG. 1, during duration 2, a single input image 3 is processed to generate a corresponding output frame 3, a single input image 4 is processed to generate a corresponding output frame 4, and a single input image 5 is processed to generate a corresponding output frame 5. In some cases, the proposed scheme may switch from MFP to single-frame processing, with MFP disabled. Alternatively, the proposed scheme may switch from MFP to a simple algorithm for MFP such as, for example, an algorithm that uses lower computation precision. In scenario 100, when image capture condition becomes suitable for MFP again (e.g., during the time period of “duration 3” shown in FIG. 1), the proposed scheme may switch from single-frame processing or the simple algorithm back to MFP to achieve improved quality. As shown in FIG. 1, during duration 3, multiple input images 6-1, 6-2, 6-3 and 6-4 are used for MFP to generate a corresponding output frame 6. Likewise, multiple input images 7-1, 7-2, 7-3 and 7-4 are used for MFP to generate a corresponding output frame 7.

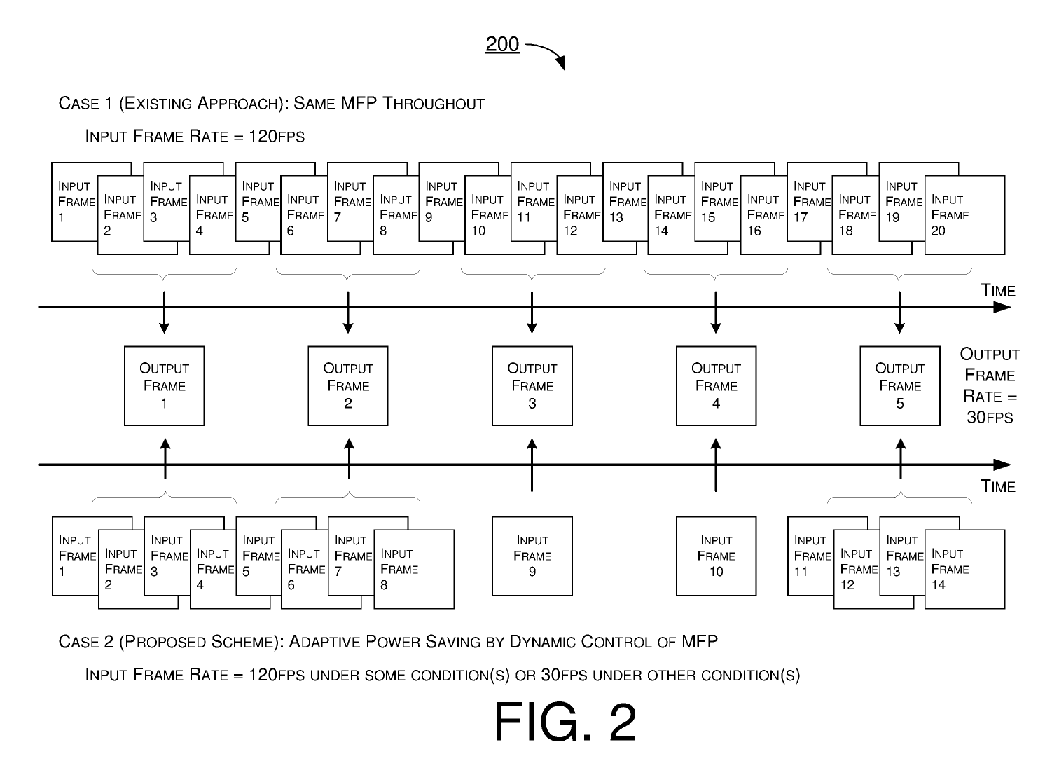

FIG. 2 illustrates an example scenario 200 in accordance with an implementation of the present disclosure. In scenario 200, input frames for MFP to generate video frames are captured by a single camera at different times. In scenario 200, when a condition being monitored is under a first condition (e.g., the thermal condition of an apparatus associated with the camera is low) and under the proposed scheme of the present disclosure, MFP may be utilized for improved quality in the output image frames. Conversely, when the condition being monitored is under a second condition (e.g., the thermal condition of the apparatus is high) and under the proposed scheme of the present disclosure, MFP may be disabled to reduce power consumption and, thereby, lower the thermal condition.

In case 1 in scenario 200 and under an existing approach, MFP would be utilized by generating each output frame with multiple input frames, respectively. That is, input frames may be captured at a constant rate (e.g., 120 frame per second (fps) or another fps), and multiple input frames (e.g., four input frames or any number greater than 1) may be processed to generate a corresponding output frame (e.g., video frame). For example, as shown in the upper portion of FIG. 2, input frames 1, 2, 3 and 4 may be processed to generate a corresponding output frame 1; input frames 5, 6, 7 and 8 may be processed to generate a corresponding output frame 2; input frames 9, 10, 11 and 12 may be processed to generate a corresponding output frame 3; input frames 13, 14, 15 and 16 may be processed to generate a corresponding output frame 4; and input frames 17, 18, 19 and 20 may be processed to generate output frame 5. Accordingly, a constant input rate (e.g., at 120 fps) may be maintained under the existing approach in producing the output frames (e.g., at 30 fps), regardless of one or more conditions (e.g., thermal condition(s)) of one or more components of the apparatus associated with the camera that is capturing the multiple input frames.

In contrast, under the proposed scheme and in case 2 of scenario 200, the utilization of MFP may be dynamically enabled/disabled, adjusted, throttled or otherwise controlled to result in power saving by adapting to real-time thermal condition(s) (and/or one or more other types of conditions) of the apparatus. For example, as shown in the lower portion of FIG. 2, MFP may be enabled when a monitored condition is under a first condition (e.g., thermal condition(s) of one or more components of the apparatus associated with the camera is low). Accordingly, under a normal mode for the first condition, input frames 1, 2, 3 and 4 may be processed to generate a corresponding output frame 1, and input frames 5, 6, 7 and 8 may be processed to generate a corresponding output frame 2. However, when the monitored condition is under a second condition different from the first condition (e.g., thermal condition(s) of one or more components of the apparatus associated with the camera is high), MFP may be disabled or a simple MFP algorithm may be utilized (e.g., with lower computation precision) to save power. Accordingly, under a power-saving mode for the second condition, a single input frame 9 may be processed to generate a corresponding output frame 3, and a single input frame 10 may be processed to generate a corresponding output frame 4. When the monitored condition returns to the first condition (e.g., thermal condition(s) of one or more components of the apparatus associated with the camera is low), MFP may be re-enabled. Accordingly, under the first condition, input frames 11, 12, 13 and 14 may be processed to generate a corresponding output frame 5. Thus, input rate may dynamically vary (e.g., changing from 120 fps to 30 fps and from 30 fps to 120 fps) depending on the real-time condition of the condition being monitored. Consequently, power saving may be adaptively achieved based on dynamic control (e.g., enabling and disabling) of MFP in processing input frames to generate corresponding output frames.

It is noteworthy that the condition(s) being monitored in scenario 200 may include, for example and without limitation, thermal condition, usage time, bandwidth and/or battery power level associated with the apparatus. It is also noteworthy that the condition(s) being monitored may be user-defined and, accordingly, a user may define which mode (e.g., normal mode or power-saving mode) corresponds to which condition(s).

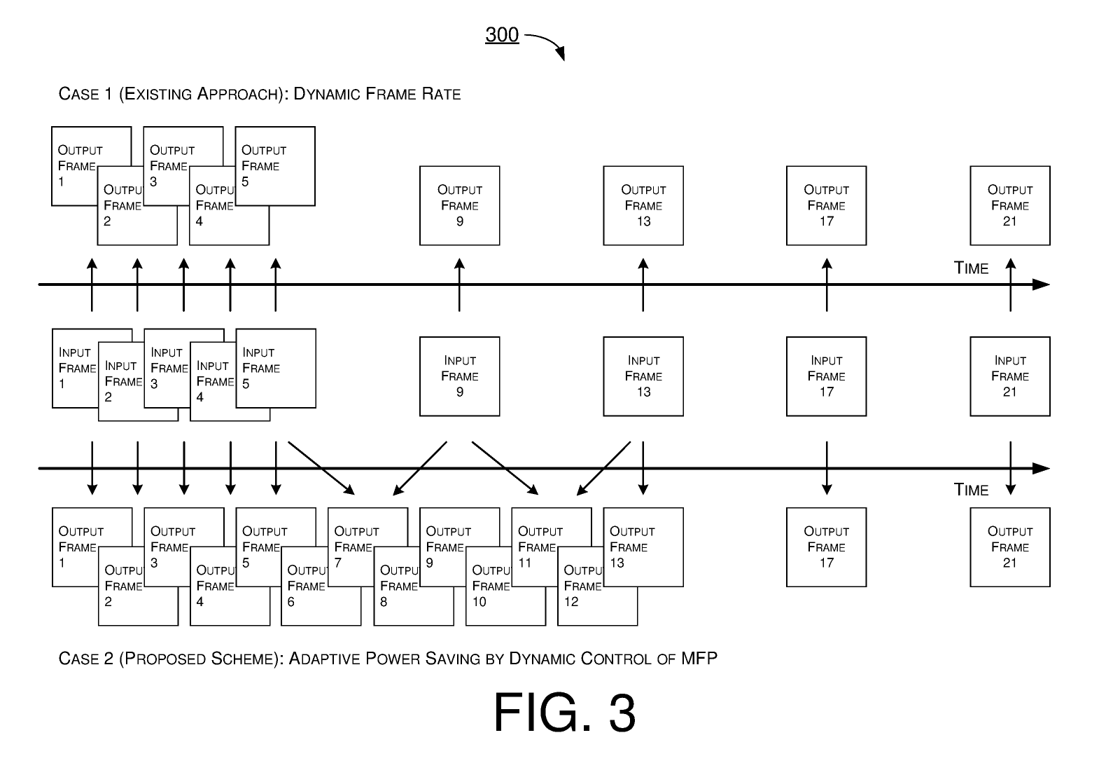

FIG. 3 illustrates an example scenario 300 in accordance with an implementation of the present disclosure. In scenario 300, input frames for MFP to generate video frames are captured by a single camera at different times. In scenario 300, when a condition being monitored is under a first condition (e.g., the thermal condition of an apparatus associated with the camera is low) and under the proposed scheme of the present disclosure, MFP may be utilized to perform frame rate conversion. Conversely, when the condition being monitored is under a second condition (e.g., the thermal condition of the apparatus is high) and under the proposed scheme of the present disclosure, MFP may be disabled to reduce power consumption and, thereby, lower the thermal condition.

In case 1 in scenario 300 and under an existing approach, MFP would be disabled and output frames are output by dynamic frame rate according to certain condition(s) (e.g., some frames needing more exposure time). That is, input frames may be captured at a dynamic frame rate (e.g., at 120 fps under one condition and at 30 fps under another condition) and processed to generate corresponding output frames (e.g., video frames). For example, as shown in the upper portion of FIG. 3, input frames 1, 2, 3, 4 and 5, which are captured at 120 fps, may be processed to generate corresponding output frames 1, 2, 3, 4 and 5, respectively; and input frames 9, 13, 17 and 21, which are captured at 30 fps, may be processed to generate corresponding output frames 9, 13, 17 and 21, respectively. Accordingly, when the input frame rate is low the output frame rate is correspondingly low, and there is no MFP utilized in generating the output frames when input frame rate is low.

In contrast, under the proposed scheme and in case 2 of scenario 300, the utilization of MFP may be dynamically enabled/disabled, adjusted, throttled or otherwise controlled to result in power saving by adapting to real-time thermal condition(s) (and/or one or more other types of conditions being monitored) of the apparatus. For example, as shown in the lower portion of FIG. 3, MFP may be enabled when a monitored condition is under a first condition (e.g., thermal condition(s) of one or more components of the apparatus associated with the camera is low). Accordingly, under a normal mode for the first condition, input frames 1, 2, 3, 4 and 5 may be processed to generate corresponding output frames 1, 2, 3, 4 and 5 (e.g., at 120 fps and the input frames correspond to/output the output frames). When some condition(s) is/are met such as when some frames needing longer exposure time, the frame rate may be reduced (e.g., from 120 fps to 30 fps), and MFP may be enabled to improve the frame rate (e.g., MFP may improve the frame rate such as increasing the frame rate from 30 fps to 120 fps). However, when the monitored condition is under a second condition different from the first condition (e.g., thermal condition(s) of one or more components of the apparatus associated with the camera is high), MFP may be disabled to reduce power. In other words, MFP may be dynamically controlled (enabled and disabled) or a simple MFP algorithm may be utilized (e.g., with lower computation precision) to save power. In the example shown in FIG. 3, MFP may be dynamically enabled for frame rate conversion in generating output frames 6, 7 and 8 by processing input frames 5 and 9. Similarly, MFP may also be dynamically enabled for frame rate conversion in generating output frames 10, 11 and 12 by processing input frames 9 and 13. The exposure time of video frames, when thermal condition is low, may be longer than the exposure time of video frames when thermal condition is high. On the other hand, MFP may be dynamically disabled to save power in generating output frames 13, 17 and 21 by processing input frames 13, 17 and 21. It is noteworthy that the capture time of each video frame may not be related to MFP, but may be related to one or more other factors. For instance, in a darker environment, longer exposure time may be needed and frame rate may be decreased. In order to avoid the frame rate from being decreased, MFP may be enabled to maintain the frame rate at a certain value. However, when thermal condition is high (e.g., the temperature of a processor and/or smartphone having the processor is high), MFP may be disabled to save power. Accordingly, frame rate may correspondingly be decreased.

It is noteworthy that the condition(s) being monitored in scenario 300 may include, for example and without limitation, thermal condition, usage time, bandwidth and/or battery power level associated with the apparatus. It is also noteworthy that the condition(s) being monitored may be user-defined and, accordingly, a user may define which mode (e.g., normal mode or power-saving mode) corresponds to which condition(s).

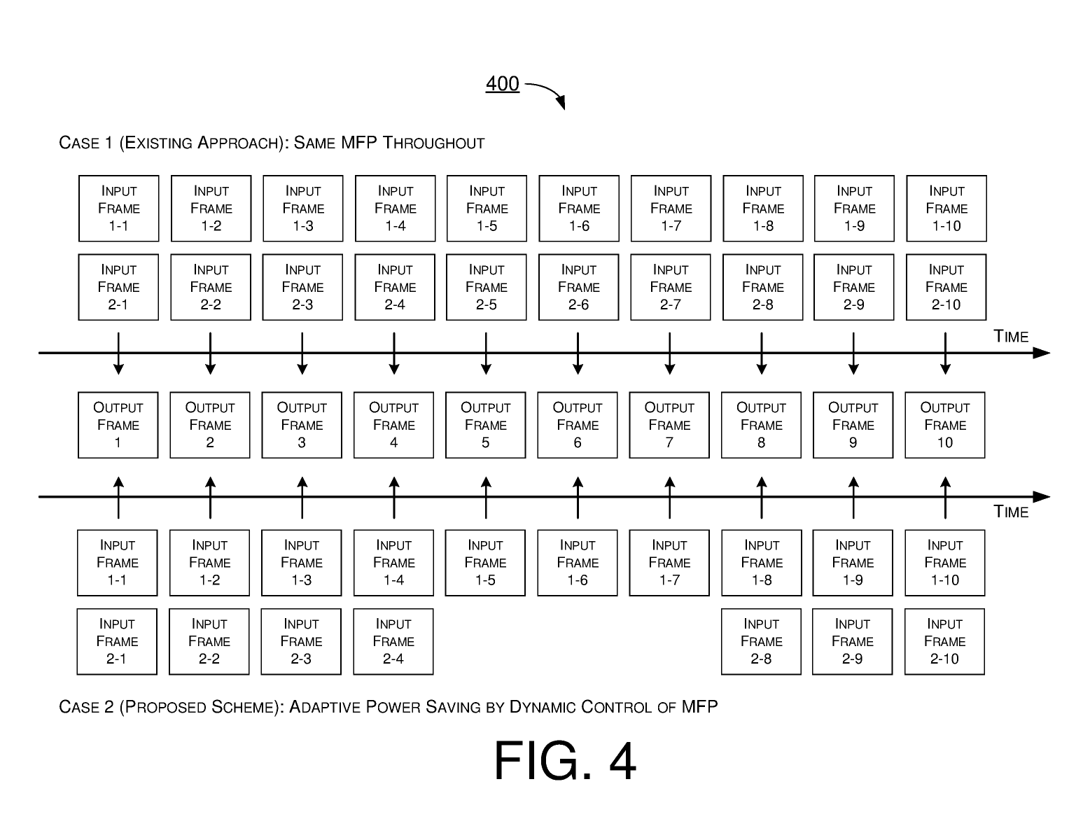

FIG. 4 illustrates an example scenario 400 in accordance with an implementation of the present disclosure. In scenario 400, input frames for MFP to generate a given video frame are captured by multiple (different) cameras at the same time. In scenario 400, when a condition being monitored is under a first condition (e.g., the thermal condition of an apparatus associated with the multiple cameras is low) and under the proposed scheme of the present disclosure, MFP may be utilized for improved quality in the output image frames (e.g., to denoise or deblur). Conversely, when the condition being monitored is under a second condition (e.g., the thermal condition of the apparatus is high) and under the proposed scheme of the present disclosure, MFP may be disabled to reduce power consumption and, thereby, lower the thermal condition.

In some implementations, the multiple cameras may use the same lens module or different lens modules. In some implementations, the multiple cameras may have different resolutions (e.g., 13 million pixels and 5 million pixels), different color filter arrays (e.g., Bayer and mono), different f-numbers (e.g., 2.0 and 2.4), and/or field of views (FOV). In some implementations, to save power for the multiple cameras, at least one camera of the multiple cameras may be disabled. Alternatively or additionally, MFP computation may be disabled. Alternatively or additionally, lower computation precision in hardware and/or software may be utilized (e.g., from 32 bits to 16 bits).

In case 1 in scenario 400 and under an existing approach, MFP would be utilized by generating each output frame with multiple input frames, respectively. That is, input frames may be captured at a constant rate (e.g., 120 fps), and multiple input frames (e.g., two input frames or any number greater than 1) may be processed to generate a corresponding output frame (e.g., video frame). For example, as shown in the upper portion of FIG. 4, input frames 1-1 and 2-1 (e.g., captured by camera 1 and camera 2 at time 1) may be processed to generate a corresponding output frame 1; input frames 1-2 and 2-2 (e.g., captured by camera 1 and camera 2 at time 2) may be processed to generate a corresponding output frame 2; input frames 1-3 and 2-3 (e.g., captured by camera 1 and camera 2 at time 3) may be processed to generate a corresponding output frame 3; and so on. Accordingly, a constant input rate (e.g., at 120 fps) may be maintained under the existing approach in producing the output frames (e.g., at 120 fps), regardless of one or more conditions (e.g., thermal condition(s)) of one or more components of the apparatus associated with the multiple cameras that are capturing the multiple input frames.

In contrast, under the proposed scheme and in case 2 of scenario 400, the utilization of MFP may be dynamically enabled/disabled, adjusted, throttled or otherwise controlled to result in power saving by adapting to real-time thermal condition(s) (and/or one or more other types of conditions) of the apparatus. For example, as shown in the lower portion of FIG. 4, MFP may be enabled when a monitored condition is under a first condition (e.g., thermal condition(s) of one or more components of the apparatus associated with the multiple cameras is low). Accordingly, under a normal mode for the first condition, input frames 1-1 and 2-1 may be processed to generate a corresponding output frame 1; input frames 1-2 and 2-2 may be processed to generate a corresponding output frame 2; input frames 1-3 and 2-3 may be processed to generate a corresponding output frame 3; and input frames 1-4 and 2-4 may be processed to generate a corresponding output frame 4. However, when the monitored condition is under a second condition different from the first condition (e.g., thermal condition(s) of one or more components of the apparatus associated with the multiple cameras is high), MFP may be disabled or a simple MFP algorithm may be utilized (e.g., with lower computation precision) to save power. For instance, a simple MFP algorithm such as that used in case 1 in scenario 300 described above may be utilized to save power. Accordingly, under a power-saving mode for the second condition, a single input frame 1-5 may be processed to generate a corresponding output frame 5; a single input frame 1-6 may be processed to generate a corresponding output frame 6; and a single input frame 1-7 may be processed to generate a corresponding output frame 7. When the monitored condition returns to the first condition (e.g., thermal condition(s) of one or more components of the apparatus associated with the camera is low), MFP may be re-enabled. Accordingly, under the first condition, input frames 1-8 and 2-8 may be processed to generate a corresponding output frame 8; input frames 1-9 and 2-9 may be processed to generate a corresponding output frame 9; and input frames 1-10 and 2-10 may be processed to generate a corresponding output frame 10. Thus, input rate may dynamically vary (e.g., changing from 120 fps to 60 fps and from 60 fps to 120 fps) depending on the real-time condition of the condition being monitored. It is noteworthy that the change (e.g., decrease) in the frame rate may vary. For instance, one camera may stay at 120 fps input rate while another camera may be disabled (e.g., not capturing image frames), or MFP may be disabled. Consequently, power saving may be adaptively achieved based on dynamic control (e.g., enabling and disabling) of MFP in processing input frames to generate corresponding output frames.

It is noteworthy that the condition(s) being monitored in scenario 400 may include, for example and without limitation, thermal condition, usage time, bandwidth and/or battery power level associated with the apparatus. It is also noteworthy that the condition(s) being monitored may be user-defined and, accordingly, a user may define which mode (e.g., normal mode or power-saving mode) corresponds to which condition(s).

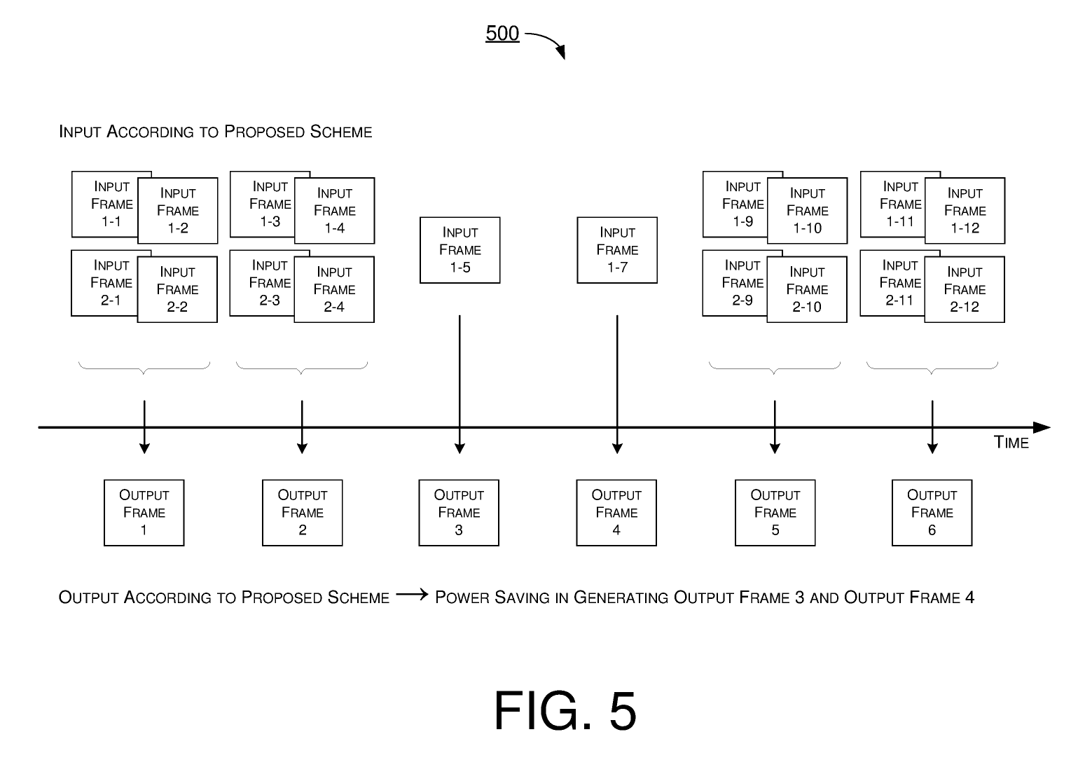

FIG. 5 illustrates an example scenario 500 in accordance with an implementation of the present disclosure. In scenario 500, input frames for MFP to generate a given video frame are captured by multiple (different) cameras at the same time and/or different times. That is, scenario 500 may be a combination of scenario 200 and scenario 400 described above. In scenario 500, when a condition being monitored is under a first condition (e.g., the thermal condition of an apparatus associated with the multiple cameras is low) and under the proposed scheme of the present disclosure, MFP may be utilized for improved quality in the output image frames (e.g., to denoise or deblur). Conversely, when the condition being monitored is under a second condition (e.g., the thermal condition of the apparatus is high) and under the proposed scheme of the present disclosure, MFP may be disabled to reduce power consumption and, thereby, lower the thermal condition.

In the example shown in FIG. 5, when the thermal condition is low, respective multiple input frames may be processed using MFP to generate a corresponding output frame (e.g., for output frames 1, 2, 5 and 6). When the thermal condition is high, a single input frame may be processed to generate a corresponding output frame (e.g., for output frames 3 and 4) to save power.

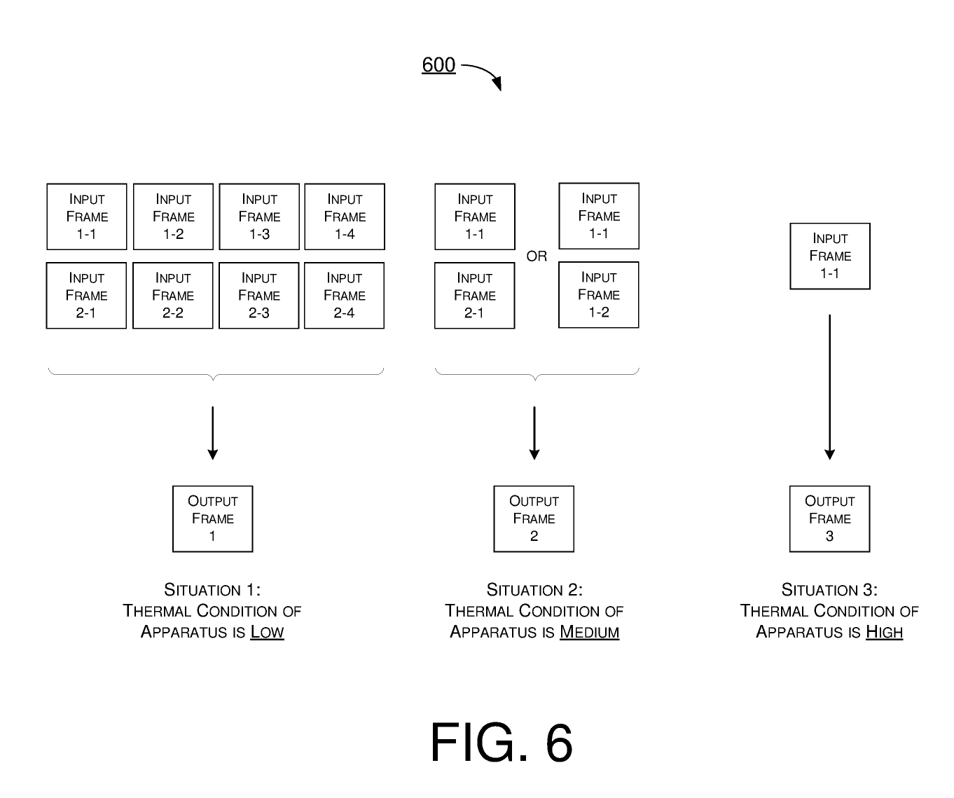

FIG. 6 illustrates an example scenario 600 in accordance with an implementation of the present disclosure. In scenario 600, input frames for MFP to generate a given video frame are captured by a single camera at the same time or different times and/or by multiple (different) cameras at the same time and/or different times. That is, scenario 600 may be a combination of scenario 200, scenario 400 and scenario 500 described above. In scenario 600, when a condition being monitored is under a first condition (e.g., the thermal condition of an apparatus associated with the multiple cameras is low) and under the proposed scheme of the present disclosure, MFP may be utilized for improved quality in multiple input image frames (e.g., eight) in generating a corresponding output frame (e.g., to denoise or deblur). When the condition being monitored is under a second condition (e.g., the thermal condition of the apparatus is medium) and under the proposed scheme of the present disclosure, MFP may be utilized for improved quality in a smaller number of multiple input image frames (e.g., two) in generating a corresponding output frame (e.g., to denoise or deblur). When the condition being monitored is under a third condition (e.g., the thermal condition of the apparatus is high) and under the proposed scheme of the present disclosure, MFP may be disabled to reduce power consumption and, thereby, lower the thermal condition. In such cases (e.g., when thermal condition of the apparatus is high), a simple MFP algorithm may be utilized (e.g., with lower computation precision) to save power. For instance, a simple MFP algorithm such as that used in case 1 in scenario 300 described above may be utilized to save power.

In the example shown in FIG. 6, input frames for MFP to generate a given video frame are captured by multiple cameras at the same time and at different times. When the thermal condition is low, eight input frames 1-1, 2-1, 1-2, 2-2, 1-3, 2-3, 1-4 and 2-4 may be processed using MFP to generate output frame 1. Input frames 1-1 and 2-1 may be captured by camera 1 and camera 2 at time 1. Input frames 1-2 and 2-2 may be captured by camera 1 and camera 2 at time 2. Input frames 1-3 and 2-3 may be captured by camera 1 and camera 2 at time 3. Input frames 1-4 and 2-4 may be captured by camera 1 and camera 2 at time 4. When the thermal condition is medium, two input frames 1-1 and 2-1 (captured by camera 1 and camera 2 at time 1) or two input frames 1-1 and 1-2 (captured by camera 1 at time 1 and time 2) may be processed using MFP to generate output frame 2. When the thermal condition is high, a single input frame 1-1 may be processed to generate output frame 3.

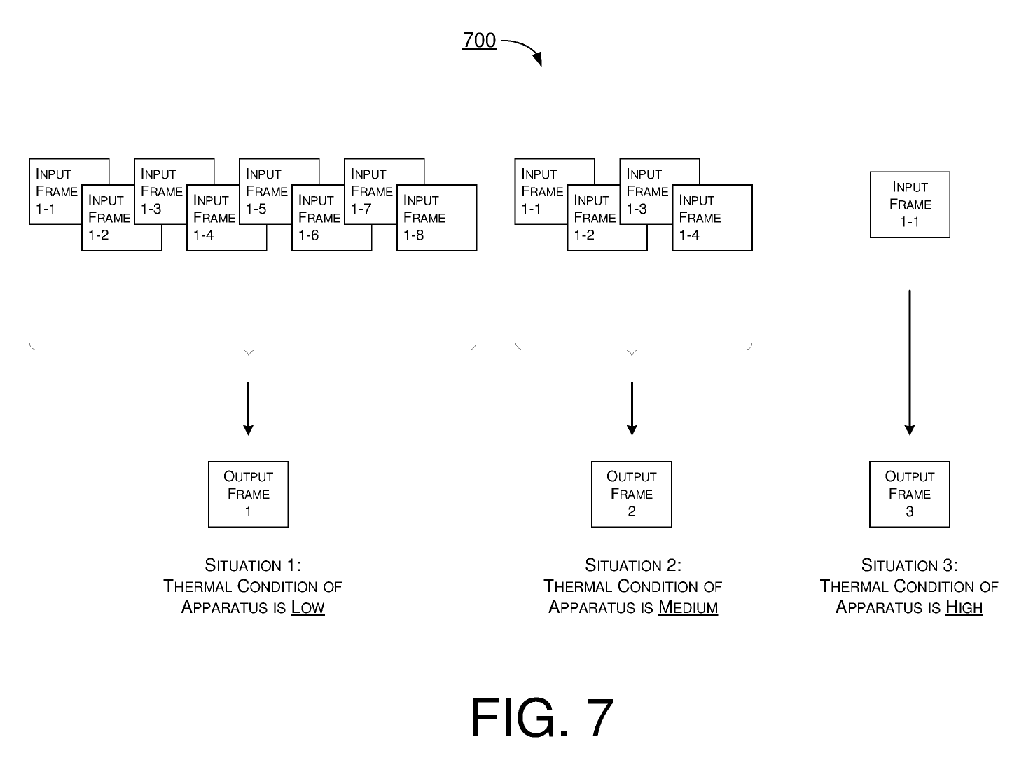

FIG. 7 illustrates an example scenario 700 in accordance with an implementation of the present disclosure. In scenario 700, input frames for MFP to generate a given video frame are captured by a single camera at different times and/or by multiple (different) cameras at the same time or different times. In scenario 700, when a condition being monitored is under a first condition (e.g., the thermal condition of an apparatus associated with the multiple cameras is low) and under the proposed scheme of the present disclosure, MFP may be utilized for improved quality in multiple input image frames (e.g., eight) in generating a corresponding output frame (e.g., to denoise or deblur). When the condition being monitored is under a second condition (e.g., the thermal condition of the apparatus is medium) and under the proposed scheme of the present disclosure, MFP may be utilized for improved quality in a smaller number of multiple input image frames (e.g., four) in generating a corresponding output frame (e.g., to denoise or deblur). When the condition being monitored is under a third condition (e.g., the thermal condition of the apparatus is high) and under the proposed scheme of the present disclosure, MFP may be disabled to reduce power consumption and, thereby, lower the thermal condition.

In the example shown in FIG. 7, input frames for MFP to generate a given video frame are captured by a single camera at different times. When the thermal condition is low, eight input frames 1-1, 1-2, 1-3, 1-4, 1-5, 1-6, 1-7 and 1-8 may be processed using MFP to generate output frame 1. Input frames 1-1, 1-2, 1-3, 1-4, 1-5, 1-6, 1-7 and 1-8 may be captured by camera 1 at times 1, 2, 3, 4, 5, 6, 7 and 8. When the thermal condition is medium, four input frames 1-1, 1-2, 1-3 and 1-4 may be processed using MFP to generate output frame 2. When the thermal condition is high, a single input frame 1-1 may be processed to generate output frame 3.

### Illustrative Implementations

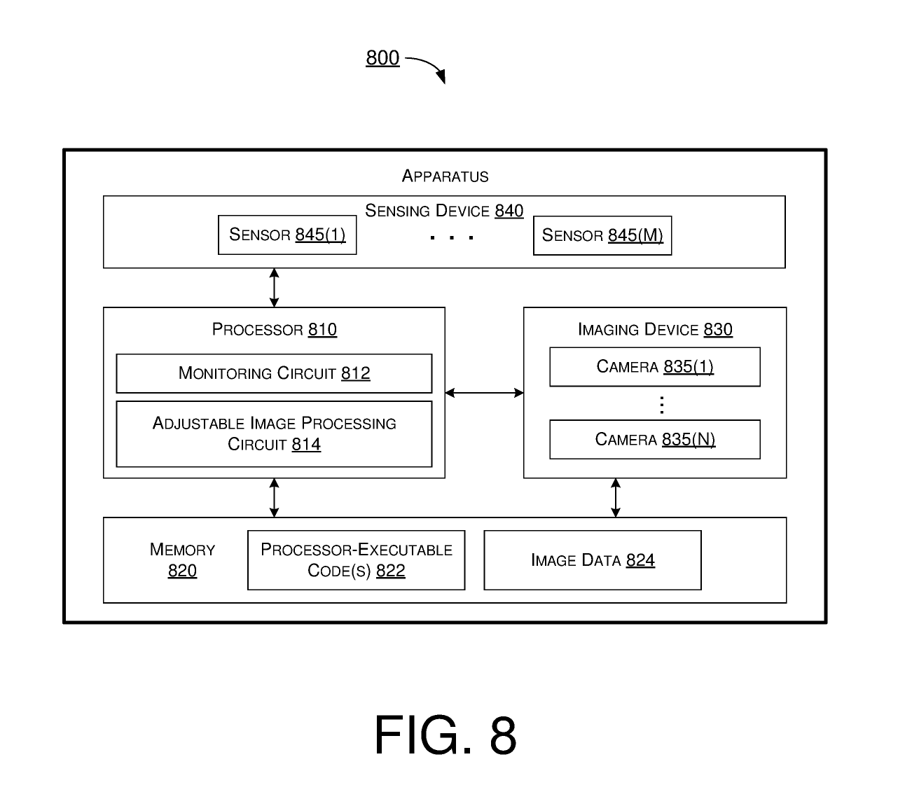

FIG. 8 illustrates an example apparatus 800 in accordance with an implementation of the present disclosure. Apparatus 800 may perform various functions to implement schemes, techniques, processes and methods described herein pertaining to adaptive power saving for multi-frame processing, including scenarios 100, 200, 300, 400, 500, 600 and 700 described above as well as process 900 described below. Apparatus 800 may be a part of an electronic apparatus, which may be a portable or mobile apparatus, a wearable apparatus, a wireless communication apparatus or a computing apparatus. For instance, apparatus 800 may be implemented in a smartphone, a smartwatch, a smart bracelet, a smart necklace, a personal digital assistant, a digital camera, or a computing equipment such as a tablet computer, a laptop computer, a notebook computer, a desktop computer, or a server. Alternatively, apparatus 800 may be implemented in the form of one or more integrated-circuit (IC) chips such as, for example and not limited to, one or more single-core processors, one or more multi-core processors, or one or more complex-instruction-set-computing (CISC) processors. Apparatus 800 may include at least those components shown in FIG. 8, such as a processor 810 and a memory 820. Additionally, apparatus 800 may include an imaging device 830 configured to capture multiple input image frames at different times and/or capture multiple input image frames at the same time (simultaneously). Moreover, apparatus 800 may include a sensing device 840 configured to sense or otherwise detect one or more conditions with respect to one or more aspects of apparatus 800. Apparatus 800 may further include other components not pertinent to the proposed scheme of the present disclosure (e.g., internal power supply, communication device, display device and/or user interface device), and, thus, are neither shown in FIG. 8 nor described below in the interest of simplicity and brevity.

Memory 820 may be a storage device configured to store one or more sets of processor-executable codes, programs and/or instructions 822 as well as image data 824 of input image frames and output image frames. For example, memory 820 may be operatively coupled to processor 810 and/or imaging device 830 to receive image data 824. Memory 820 may be implemented by any suitable technology and may include volatile memory and/or non-volatile memory. For example, memory 820 may include a type of random access memory (RAM) such as dynamic RAM (DRAM), static RAM (SRAM), thyristor RAM (T-RAM) and/or zero-capacitor RAM (Z-RAM). Alternatively or additionally, memory 820 may include a type of read-only memory (ROM) such as mask ROM, programmable ROM (PROM), erasable programmable ROM (EPROM) and/or electrically erasable programmable ROM (EEPROM). Alternatively or additionally, memory 820 may include a type of non-volatile random-access memory (NVRAM) such as flash memory, solid-state memory, ferroelectric RAM (FeRAM), magnetoresistive RAM (MRAM) and/or phase-change memory.

Imaging device 830 may include one or more cameras 835(1)-835(N), where N is a positive integer greater than or equal to 1. Each of the one or more cameras 835(1)-835(N) may include a digital camera which may be implemented with, for example and without limitation, semiconductor charge-coupled device(s) (CCD) and/or active pixel sensors in complementary metal-oxide-semiconductor (CMOS) or N-type metal-oxide-semiconductor (NMOS) technologies. Each of the one or more cameras 835(1)-835(N) may be configured to capture one or more input image frames at any given time, and provide data representative of the captured input image frame(s) to processor 810 and/or memory 820 for processing and/or storage.

Sensing device 840 may include one or more sensors 845(1)-845(M), where M is a positive integer greater than or equal to 1. Each of the one or more sensors 845(1)-845(M) may be configured to sense or otherwise detect a respect condition with respect to one or more aspects of apparatus 800. In some implementations, the one or more sensors 845(1)-845(M) may include one or more temperature sensors. For instance, the one or more temperature sensors may sense one or more temperatures associated with one or more components apparatus 800 (e.g., temperature of processor 810 and/or temperature of a casing of apparatus 800). In some implementations, the one or more sensors 845(1)-845(M) may include one or more power sensors. For instance, the one or more power sensors may sense a power level of a power supply associated with apparatus 800 such as an internal power supply (e.g., battery).

In one aspect, processor 810 may be implemented in the form of one or more single-core processors, one or more multi-core processors, or one or more CISC processors. That is, even though a singular term “a processor” is used herein to refer to processor 810, processor 810 may include multiple processors in some implementations and a single processor in other implementations in accordance with the present disclosure. In another aspect, processor 810 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 810 is a special-purpose machine specifically designed, arranged and configured to perform specific tasks including adaptive power saving for multi-frame processing in accordance with various implementations of the present disclosure.

Processor 810 may be operably coupled to memory 820, imaging device 830 and sensing device 840. Processor 810 may access memory 820 to execute the one or more processor-executable codes 822 stored in memory 820. Upon executing the one or more processor-executable codes 822, processor 810 may be configured to perform operations pertaining to adaptive power saving for multi-frame processing. Processor 810 may be also operably coupled to imaging device 830 to receive input image frames, captured by the one or more cameras 835(1)-835(N), from imaging device 830. Processor 810 may be further operatively coupled to sensing device 840 to receive one or more signals from sensing device 840, with the one or more signals representative of one or more conditions sensed or otherwise detected by the one or more sensors 845(1)-845(M) of sensing device 840.

Processor 810, as a special-purpose machine, may include non-generic and specially-designed hardware circuits that are designed, arranged and configured to perform specific tasks pertaining to adaptive power saving for multi-frame processing in accordance with various implementations of the present disclosure. For instance, processor 810 may include a monitoring circuit 812 and an adjustable image processing circuit 814 that, together, perform specific tasks and functions to render adaptive power saving for multi-frame processing in accordance with various implementations of the present disclosure. For instance, monitoring circuit 812 may monitor for at least one condition associated with apparatus 800, and, in response to a result of the monitoring, adjustable image processing circuit 814 may dynamically adjust image processing performed on multiple input image frames received from imaging device 830 to provide one or more output image frames.

In some implementations, monitoring circuit 812 may, based on one or more signals received from sensing device 840, monitor one or more temperatures associated with apparatus 800 and determine whether the one or more monitored temperatures has/have reached or exceeded one or more respective thermal thresholds. For example and without limitation, monitoring circuit 812 may monitor and determine whether the temperature(s) of processor 810 (and/or one or more other circuits of apparatus 800) and/or a casing of apparatus 800 has/have reached or exceeded respective thermal threshold(s). Alternatively or additionally, monitoring circuit 812 may, based on one or more signals received from sensing device 840, monitor one or more temperatures associated with at least one of the one or more cameras 835(1)-835(N) of imaging device 830 and determine whether the one or more monitored temperatures has/have reached or exceeded one or more respective thermal thresholds. Alternatively or additionally, monitoring circuit 812 may, based on one or more signals received from sensing device 840, monitor a power level of a battery associated with apparatus 800 and determine whether the monitored power level has reached or dropped below a respective power level threshold.

In some implementations, monitoring circuit 812 may, based on signal(s), data and/or information received from one or more other hardware components of processor 810, one or more firmware components of processor 810 and/or one or more software applications executed by processor 810, monitor and determine whether an amount of time that apparatus 800 has been in use has reached or exceeded a respective temporal threshold. Alternatively or additionally, monitoring circuit 812 may, based on signal(s), data and/or information received from one or more other hardware components of processor 810, one or more firmware components of processor 810 and/or one or more software applications executed by processor 810, monitor and determine whether an amount of time that at least one of the one or more cameras 835(1)-835(N) of imaging device 830 has been in use has reached or exceeded a respective temporal threshold. Alternatively or additionally, monitoring circuit 812 may, based on signal(s), data and/or information received from one or more other hardware components of processor 810, one or more firmware components of processor 810 and/or one or more software applications executed by processor 810, monitor and determine whether an amount of time that an application in execution on apparatus 800 has reached or exceeded a respective temporal threshold. Alternatively or additionally, monitoring circuit 812 may, based on signal(s), data and/or information received from one or more other hardware components of processor 810, one or more firmware components of processor 810 and/or a communication device of apparatus 800, monitor and determine whether a bandwidth associated with apparatus 800 has reached or dropped below a respective bandwidth threshold. Alternatively or additionally, monitoring circuit 812 may, based on signal(s), data and/or information received from one or more other hardware components of processor 810, one or more firmware components of processor 810 and/or a user interface device of apparatus 800, monitor and determine whether a user input, which changes a mode of the image processing performed on the multiple input image frames, has been received.

In some implementations, in dynamically adjusting the image processing, adjustable image processing circuit 814 may be configured to perform multi-frame processing (MFP) on the multiple input image frames. For instance, adjustable image processing circuit 814 may perform MFP to achieve at least one of the following: denoising, deblurring, super-resolution imaging, high dynamic range improvement, sharpness improvement, texture improvement, brightness improvement, color improvement and contrast improvement.

In some implementations, processor 810 may receive the multiple input image frames from a single camera of imaging device 830, where the multiple input image frames may be captured by the single camera at different times. In such cases, in dynamically adjusting image processing performed on the multiple input image frames to provide the one or more output image frames, adjustable image processing circuit 814 may be configured to perform a number of operations. For instance, adjustable image processing circuit 814 may perform a first mode of image processing on the multiple input image frames to provide the one or more output image frames when there is no occurrence of the at least one condition. Moreover, adjustable image processing circuit 814 may perform a second mode of image processing on the multiple input image frames to provide the one or more output image frames when there is an occurrence of the at least one condition.

In performing the first mode of image processing on the multiple input image frames to provide the one or more output image frames, adjustable image processing circuit 814 may be configured to perform either of the following: (i) generating each output image frame of the one or more output image frames using a first number of respective input image frames of the multiple input image frames, and (ii) generating the first number of output image frames of the one or more output image frames using a second number of respective input image frames of the multiple input image frames. In performing the second mode of image processing on the multiple input image frames to provide the one or more output image frames, adjustable image processing circuit 814 may be configured to perform either of the following: (i) generating each output image frame of the one or more output image frames using the second number of respective input image frames of the multiple input image frames, and (ii) generating a third number of output image frames of the one or more output image frames using the second number of respective input image frames of the multiple input image frames. Here, the second number may be less than the first number, and the third number may be less than or not equal to the first number.

In some implementations, processor 810 may receive the multiple input image frames from multiple cameras of imaging device 830, where the multiple input image frames may be captured by the multiple cameras in batches at different times with each batch of input image frames captured simultaneously by the multiple cameras at a respective time. In such cases, in dynamically adjusting the image processing performed on multiple input image frames to provide one or more output image frames, adjustable image processing circuit 814 may be configured to perform a number of operations. For instance, adjustable image processing circuit 814 may perform a first mode of image processing on the multiple input image frames to provide the one or more output image frames when there is no occurrence of the at least one condition. Furthermore, adjustable image processing circuit 814 may perform a second mode of image processing on the multiple input image frames to provide the one or more output image frames when there is an occurrence of the at least one condition.

In performing the first mode of image processing on the multiple input image frames to provide the one or more output image frames, adjustable image processing circuit 814 may be configured to perform either of the following: (i) generating each output image frame of the one or more output image frames using a respective batch of input image frames of the multiple input image frames, and (ii) generating each output image frame of the one or more output image frames using more than one respective batch of input image frames of the multiple input image frames. In performing the second mode of image processing on the multiple input image frames to provide the one or more output image frames, adjustable image processing circuit 814 may be configured to perform either of the following: (i) generating each output image frame of the one or more output image frames using a respective input image frame captured by one of the multiple cameras at a respective time, and (ii) generating each output image frame of the one or more output image frames using a respective input image frame captured by one of the multiple cameras at a respective time.

In some implementations, processor 810 may receive the multiple input image frames from one or more cameras of imaging device 830, where the multiple input image frames may be captured by a single camera of the one or more cameras at different times, by more than one camera of the one or more cameras in batches at different times, or by a combination thereof. Each batch of input image frames may be captured simultaneously by the more than one camera of the one or more cameras at a respective time. In such cases, in dynamically adjusting the image processing performed on the multiple input image frames to provide the one or more output image frames, adjustable image processing circuit 814 may be configured to perform a respective mode of multiple modes of image processing on the multiple input image frames to provide the one or more output image frames under a respective condition of a number of conditions. For instance, under a first condition, adjustable image processing circuit 814 may generate each output image frame of the one or more output image frames using a first number of respective input image frames of the multiple input image frames captured by the single camera or the more than one camera of the one or more cameras at different times. Additionally, under a second condition, adjustable image processing circuit 814 may generate each output image frame of the one or more output image frames using a second number of respective input image frames of the multiple input image frames captured by the single camera or the more than one camera of the one or more cameras at different times. Moreover, under a third condition, adjustable image processing circuit 814 may generate each output image frame of the one or more output image frames using a third number of respective input image frames of the multiple input image frames captured by the single camera or the more than one camera of the one or more cameras at different times. Here, the second number may be less than the first number, and the third number may be less than or not equal to the first number.

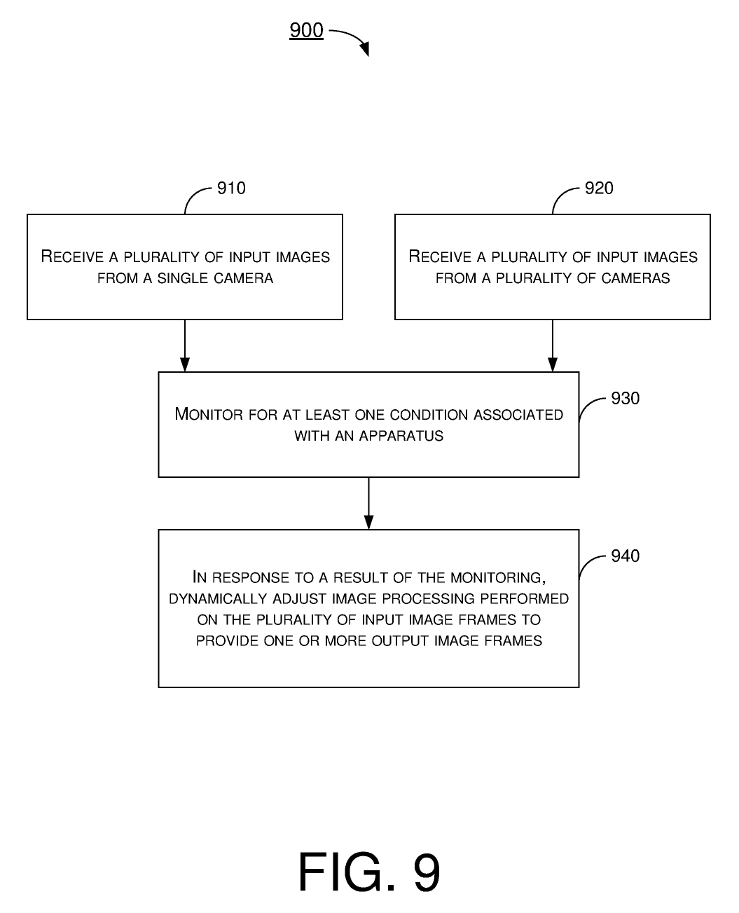

FIG. 9 illustrates an example process 900 in accordance with an implementation of the present disclosure. Process 900 may be an example implementation of any of scenarios 100, 200, 300, 400, 500, 600 and/or 700, whether partially or completely, with respect to adaptive power saving for multi-frame processing. Process 900 may represent an aspect of implementation of features of apparatus 800. Process 900 may include one or more operations, actions, or functions as illustrated by one or more of blocks 910, 920, 930 and 940. Although illustrated as discrete blocks, various blocks of process 900 may be divided into additional blocks, combined into fewer blocks, or eliminated, depending on the desired implementation. Moreover, the blocks of process 900 may executed in the order shown in FIG. 9 or, alternatively, in a different order. Process 900 may be implemented by apparatus 800. Solely for illustrative purposes and without limitation, process 900 is described below in the context of apparatus 800. Process 900 may begin at either block 910 or block 920.

At 910, process 900 may involve processor 810 of apparatus 800 receiving multiple input images from a single camera. Process 900 may proceed from 910 to 930.

At 920, process 900 may involve processor 810 of apparatus 800 receiving multiple input images from multiple cameras. Process 900 may proceed from 920 to 930.

At 930, process 900 may involve processor 810 of apparatus 800 monitoring for at least one condition associated with apparatus 800. Process 900 may proceed from 930 to 940.

At 940, process 900 may involve processor 810 of apparatus 800, in response to a result of the monitoring, dynamically adjusting image processing performed on the multiple input image frames to provide one or more output image frames.

In some implementations, in monitoring for the at least one condition related to apparatus 800, process 900 may involve processor 810 monitoring for an occurrence of one or more conditions of a number of conditions related to apparatus 800. For instance, such conditions may include the following: one or more temperatures associated with apparatus 800 reaching or exceeding one or more respective thermal thresholds, one or more temperatures associated with a camera of apparatus 800 reaching or exceeding one or more respective thermal thresholds, an amount of time that apparatus 800 has been in use reaching or exceeding a respective temporal threshold, an amount of time that the camera of apparatus 800 has been in use reaching or exceeding a respective temporal threshold, and an amount of time that an application has been in execution on apparatus 800 reaching or exceeding a respective temporal threshold.

In some implementations, in monitoring for the at least one condition related to apparatus 800, process 900 may involve processor 810 monitoring for an occurrence of one or more conditions of a number of conditions related to apparatus 800. For instance, such conditions may include the following: a bandwidth associated with apparatus 800 reaching or dropping below a respective bandwidth threshold, a power level of a battery associated with apparatus 800 reaching or dropping below a respective power level threshold, and receipt of a user input that changes a mode of the image processing performed on the plurality of input image frames.

In some implementations, the multiple input image frames may be received from a single camera and captured by the single camera at different times. In such cases, in dynamically adjusting the image processing performed on the multiple input image frames to provide the one or more output image frames, process 900 may involve processor 810 performing a first mode of image processing on the multiple input image frames to provide the one or more output image frames when there is no occurrence of the at least one condition. For instance, processor 810 may generate each output image frame of the one or more output image frames using a first number of respective input image frames of the multiple input image frames. Process 900 may also involve processor 810 performing a second mode of image processing on the multiple input image frames to provide the one or more output image frames when there is an occurrence of the at least one condition. For instance, processor 810 may generate each output image frame of the one or more output image frames using a second number of respective input image frames of the multiple input image frames, where the second number may be less than the first number.

Alternatively, in performing the first mode of image processing on the multiple input image frames to provide the one or more output image frames, process 900 may involve processor 810 generating a first number of output image frames of the one or more output image frames using a second number of respective input image frames of the multiple input image frames. Moreover, in performing the second mode of image processing on the multiple input image frames to provide the one or more output image frames, process 900 may involve processor 810 generating a third number of output image frames of the one or more output image frames using the second number of respective input image frames of the multiple input image frames. Here, the second number may be less than the first number, and the third number may be less than or not equal to the first number.

In some implementations, the multiple input image frames may be received from multiple cameras and captured in batches by the multiple cameras at different times, with each batch of input image frames being captured simultaneously by the multiple cameras at a respective time. In such cases, in dynamically adjusting the image processing performed on the multiple input image frames to provide the one or more output image frames, process 900 may involve processor 810 performing a first mode of image processing on the multiple input image frames to provide the one or more output image frames when there is no occurrence of the at least one condition. For instance, processor 810 may generate each output image frame of the one or more output image frames using one or more than one respective batch of input image frames of the multiple input image frames. Process 900 may also involve processor 810 performing a second mode of image processing on the multiple input image frames to provide the one or more output image frames when there is an occurrence of the at least one condition. For instance, processor 810 may generate each output image frame of the one or more output image frames using a respective input image frame captured by one of the multiple cameras at a respective time.

In some implementations, the multiple input image frames may be received from one or more cameras. The multiple input image frames may be captured by a single camera of the one or more cameras at different times, by more than one camera of the one or more cameras in batches at different times, or by a combination thereof. In such cases, each batch of input image frames may be captured simultaneously by the more than one camera of the one or more cameras at a respective time. Moreover, in dynamically adjusting the image processing performed on the multiple input image frames to provide the one or more output image frames, process 900 may involve processor 810 performing a respective mode of multiple modes of image processing on the multiple input image frames to provide the one or more output image frames under a respective condition of a plurality of conditions. In some implementations, in performing the respective mode of the multiple modes of image processing on the multiple input image frames to provide the one or more output image frames under the respective condition of the multiple conditions, process 900 may involve processor 810 performing a number of operations. For instance, under a first condition, process 900 may involve processor 810 generating each output image frame of the one or more output image frames using a first number of respective input image frames of the multiple input image frames captured by the single camera or the more than one camera of the one or more cameras at different times. Under a second condition, process 900 may involve processor 810 generating each output image frame of the one or more output image frames using a second number of respective input image frames of the multiple input image frames captured by the single camera or the more than one camera of the one or more cameras at different times. Under a third condition, process 900 may involve processor 810 generating each output image frame of the one or more output image frames using a third number of respective input image frames of the multiple input image frames captured by the single camera or the more than one camera of the one or more cameras at different times. Here, the second number may be less than the first number, and the third number may be less than or not equal to the first number.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
monitoring for at least one condition associated with an apparatus; and
responsive to a result of the monitoring, dynamically adjusting image processing performed on a plurality of input image frames to provide one or more output image frames.

2. The method of claim 1, wherein the monitoring for the at least one condition related to the apparatus comprises monitoring for an occurrence of one or more conditions of a plurality of conditions related to the apparatus, the plurality of conditions comprising:
one or more temperatures associated with the apparatus reaching or exceeding one or more respective thermal thresholds;
one or more temperatures associated with a camera of the apparatus reaching or exceeding one or more respective thermal thresholds;
an amount of time that the apparatus has been in use reaching or exceeding a respective temporal threshold;
an amount of time that the camera has been in use reaching or exceeding a respective temporal threshold; and
an amount of time that an application has been in execution on the apparatus reaching or exceeding a respective temporal threshold.

3. The method of claim 1, wherein the monitoring for the at least one condition related to the apparatus comprises monitoring for an occurrence of one or more conditions of a plurality of conditions related to the apparatus, the plurality of conditions comprising:
a bandwidth associated with the apparatus reaching or dropping below a respective bandwidth threshold;
a power level of a battery associated with the apparatus reaching or dropping below a respective power level threshold; and
receiving a user input that changes a mode of the image processing performed on the plurality of input image frames.

4. The method of claim 1, further comprising:
receiving the plurality of input image frames from a single camera,
wherein the plurality of input image frames are captured by the single camera at different times, and
wherein the dynamically adjusting of the image processing performed on the plurality of input image frames to provide the one or more output image frames comprises:
performing a first mode of image processing on the plurality of input image frames to provide the one or more output image frames when there is no occurrence of the at least one condition; and
performing a second mode of image processing on the plurality of input image frames to provide the one or more output image frames when there is an occurrence of the at least one condition.

5. The method of claim 4, wherein the performing of the first mode of image processing on the plurality of input image frames to provide the one or more output image frames comprises generating each output image frame of the one or more output image frames using a first number of respective input image frames of the plurality of input image frames, wherein the performing of the second mode of image processing on the plurality of input image frames to provide the one or more output image frames comprises generating each output image frame of the one or more output image frames using a second number of respective input image frames of the plurality of input image frames, and wherein the second number is less than the first number.

6. The method of claim 4, wherein the performing of the first mode of image processing on the plurality of input image frames to provide the one or more output image frames comprises generating a first number of output image frames of the one or more output image frames using a second number of respective input image frames of the plurality of input image frames, wherein the performing of the second mode of image processing on the plurality of input image frames to provide the one or more output image frames comprises generating a third number of output image frames of the one or more output image frames using the second number of respective input image frames of the plurality of input image frames, wherein the second number is less than the first number, and wherein the third number is less than or not equal to the first number.

7. The method of claim 1, further comprising:
receiving the plurality of input image frames from a plurality of cameras,
wherein the plurality of input image frames are captured by the plurality of cameras in batches at different times such that each batch of input image frames are captured simultaneously by the plurality of cameras at a respective time, and
wherein the dynamically adjusting of the image processing performed on the plurality of input image frames to provide the one or more output image frames comprises:
performing a first mode of image processing on the plurality of input image frames to provide the one or more output image frames when there is no occurrence of the at least one condition; and
performing a second mode of image processing on the plurality of input image frames to provide the one or more output image frames when there is an occurrence of the at least one condition.

8. The method of claim 7, wherein the performing of the first mode of image processing on the plurality of input image frames to provide the one or more output image frames comprises generating each output image frame of the one or more output image frames using one or more than one respective batch of input image frames of the plurality of input image frames, and wherein the performing of the second mode of image processing on the plurality of input image frames to provide the one or more output image frames comprises generating each output image frame of the one or more output image frames using a respective input image frame captured by one of the plurality of cameras at a respective time.

9. The method of claim 1, further comprising:
receiving the plurality of input image frames from one or more cameras,
wherein the plurality of input image frames are captured by a single camera of the one or more cameras at different times, by more than one camera of the one or more cameras in batches at different times, or by a combination thereof,
wherein each batch of input image frames are captured simultaneously by the more than one camera of the one or more cameras at a respective time, and
wherein the dynamically adjusting of the image processing performed on the plurality of input image frames to provide the one or more output image frames comprises performing a respective mode of a plurality of modes of image processing on the plurality of input image frames to provide the one or more output image frames under a respective condition of a plurality of conditions.

10. The method of claim 9, wherein the performing of the respective mode of the plurality of modes of image processing on the plurality of input image frames to provide the one or more output image frames under the respective condition of the plurality of conditions comprises one of:
under a first condition, generating each output image frame of the one or more output image frames using a first number of respective input image frames of the plurality of input image frames captured by the single camera or the more than one camera of the one or more cameras at different times;
under a second condition, generating each output image frame of the one or more output image frames using a second number of respective input image frames of the plurality of input image frames captured by the single camera or the more than one camera of the one or more cameras at different times; and
under a third condition, generating each output image frame of the one or more output image frames using a third number of respective input image frames of the plurality of input image frames captured by the single camera or the more than one camera of the one or more cameras at different times,
wherein the second number is less than the first number, and wherein the third number is less than or not equal to the first number.

11. An apparatus, comprising:
a processor configured to perform operations comprising:
monitoring for at least one condition associated with an apparatus; and
responsive to a result of the monitoring, dynamically adjusting image processing performed on a plurality of input image frames to provide one or more output image frames.

12. The apparatus of claim 11, wherein, in dynamically adjusting the image processing, the processor is configured to perform multi-frame processing (MFP) on the plurality of input image frames, and wherein the MFP comprises at least one of denoising, deblurring, super-resolution imaging, high dynamic range improvement, sharpness improvement, texture improvement, brightness improvement, color improvement and contrast improvement.

13. The apparatus of claim 11, wherein the processor is further configured to receive the plurality of input image frames from a single camera, wherein the plurality of input image frames are captured by the single camera at different times, and wherein, in dynamically adjusting image processing performed on the plurality of input image frames to provide one or more output image frames, the processor is configured to perform operations comprising:
performing a first mode of image processing on the plurality of input image frames to provide the one or more output image frames when there is no occurrence of the at least one condition; and
performing a second mode of image processing on the plurality of input image frames to provide the one or more output image frames when there is an occurrence of the at least one condition.

14. The apparatus of claim 13, wherein, in performing the first mode of image processing on the plurality of input image frames to provide the one or more output image frames, the processor is configured to perform either (i) generating each output image frame of the one or more output image frames using a first number of respective input image frames of the plurality of input image frames or (ii) generating the first number of output image frames of the one or more output image frames using a second number of respective input image frames of the plurality of input image frames, wherein, in performing the second mode of image processing on the plurality of input image frames to provide the one or more output image frames, the processor is configured to perform either (i) generating each output image frame of the one or more output image frames using the second number of respective input image frames of the plurality of input image frames or (ii) generating a third number of output image frames of the one or more output image frames using the second number of respective input image frames of the plurality of input image frames, wherein the second number is less than the first number, and wherein the third number is less than or not equal to the first number.

15. The apparatus of claim 11, wherein the processor is further configured to receive the plurality of input image frames from a plurality of cameras, wherein the plurality of input image frames are captured by the plurality of cameras in batches at different times such that each batch of input image frames are captured simultaneously by the plurality of cameras at a respective time, and wherein, in dynamically adjusting the image processing performed on the plurality of input image frames to provide one or more output image frames, the processor is configured to perform operations comprising:
performing a first mode of image processing on the plurality of input image frames to provide the one or more output image frames when there is no occurrence of the at least one condition; and
performing a second mode of image processing on the plurality of input image frames to provide the one or more output image frames when there is an occurrence of the at least one condition.

16. The apparatus of claim 15, wherein, in performing the first mode of image processing on the plurality of input image frames to provide the one or more output image frames, the processor is configured to perform either (i) generating each output image frame of the one or more output image frames using a respective batch of input image frames of the plurality of input image frames or (ii) generating each output image frame of the one or more output image frames using more than one respective batch of input image frames of the plurality of input image frames, and wherein, in performing the second mode of image processing on the plurality of input image frames to provide the one or more output image frames, the processor is configured to perform either (i) generating each output image frame of the one or more output image frames using a respective input image frame captured by one of the plurality of cameras at a respective time or (ii) generating each output image frame of the one or more output image frames using a respective input image frame captured by one of the plurality of cameras at a respective time.

17. The apparatus of claim 11, wherein the processor is further configured to receive the plurality of input image frames from one or more cameras, wherein the plurality of input image frames are captured by a single camera of the one or more cameras at different times, by more than one camera of the one or more cameras in batches at different times, or by a combination thereof, wherein each batch of input image frames are captured simultaneously by the more than one camera of the one or more cameras at a respective time, and wherein, in dynamically adjusting the image processing performed on the plurality of input image frames to provide the one or more output image frames, the processor is configured to perform a respective mode of a plurality of modes of image processing on the plurality of input image frames to provide the one or more output image frames under a respective condition of a plurality of conditions.

18. The apparatus of claim 17, wherein, in performing the respective mode of the plurality of modes of image processing on the plurality of input image frames to provide the one or more output image frames under the respective condition of the plurality of conditions, the processor is configured to perform one of:
under a first condition, generating each output image frame of the one or more output image frames using a first number of respective input image frames of the plurality of input image frames captured by the single camera or the more than one camera of the one or more cameras at different times;
under a second condition, generating each output image frame of the one or more output image frames using a second number of respective input image frames of the plurality of input image frames captured by the single camera or the more than one camera of the one or more cameras at different times; and
under a third condition, generating each output image frame of the one or more output image frames using a third number of respective input image frames of the plurality of input image frames captured by the single camera or the more than one camera of the one or more cameras at different times,
wherein the second number is less than the first number, and wherein the third number is less than or not equal to the first number.

19. The apparatus of claim 11, wherein the at least one condition comprises:
one or more temperatures associated with the apparatus reaching or exceeding one or more respective thermal thresholds;
one or more temperatures associated with a camera of the apparatus reaching or exceeding one or more respective thermal thresholds;
an amount of time that the apparatus has been in use reaching or exceeding a respective temporal threshold;
an amount of time that the camera has been in use reaching or exceeding a respective temporal threshold; and
an amount of time that an application has been in execution on the apparatus reaching or exceeding a respective temporal threshold.

20. The apparatus of claim 11, wherein the at least one condition comprises:
a bandwidth associated with the apparatus reaching or dropping below a respective bandwidth threshold;
a power level of a battery associated with the apparatus reaching or dropping below a respective power level threshold; and
receiving a user input that changes a mode of the image processing performed on the plurality of input image frames.
